(19) United States
(12) Patent Application Publication
(10) Pub. No.: US 2008/0118780 A1
(43) Pub. Date: May 22, 2008

(54) MAGNETIC RECORDING MEDIUM AND METHOD OF MANUFACTURING THE SAME

(75) Inventor: Hisato KATO, Hachioji City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 11/943,579

(22) Filed: Nov. 20, 2007

(30) Foreign Application Priority Data
Nov. 22, 2006 (JP) 2006-315835

(51) Int. Cl. G11B 5/733; G11B 5/84

(52) U.S. Cl. 428/828; 427/131

(57) ABSTRACT

A discrete track type perpendicular magnetic recording medium having good crystal orientation and perpendicular magnetic anisotropy of a magnetic recording layer is disclosed. The medium is produced by a simple, inexpensive method. A soft magnetic backing layer, a base layer for crystal orientation, and a perpendicular magnetic recording layer are formed in this order on a nonmagnetic substrate, and a processing layer having a concavo-convex pattern comprising convex parts at a low density and concave parts at a higher density is provided between the nonmagnetic substrate and the perpendicular magnetic recording layer, the concavo-convex pattern shape of the processing layer being reflected on the perpendicular magnetic recording layer.

### CROSS REFERENCE TO RELATED APPLICATIONS

This application claims priority from application Serial No. JP 2006-315835, filed on Nov. 22, 2006, the contents of which are incorporated herein in their entirety by reference.

### BACKGROUND OF THE INVENTION

A. Field of the Invention

The present invention relates to a discrete track type perpendicular magnetic recording medium that can be installed in any of various magnetic disk apparatuses, and in particular relates to a magnetic recording medium that can be manufactured simply and inexpensively and moreover has excellent magnetic properties. The present invention also relates to a method of manufacturing such a magnetic recording medium.

B. Description of the Related Art

As one example of a magnetic recording method, there is known a longitudinal magnetic recording method in which magnetization data is recorded and played back along a recording head scanning direction, which is a direction parallel to the medium substrate surface.

In recent years, accompanying demands for increased capacity of magnetic recording/playback apparatuses, there have been demands to increase the recording density of magnetic recording media, but if the recording density is increased, then the area of each recording bit on the medium decreases. A thermal demagnetization phenomenon in which the state of magnetization on a magnetic recording layer of the medium becomes thermally unstable thus occurs markedly.

Instead of the longitudinal magnetic recording method, a perpendicular magnetic recording method which is a magnetic recording method for which the thermal demagnetization phenomenon is relatively unlikely to occur has thus been proposed. By using such a perpendicular magnetic recording method, the recording density can be approximately 100 to 200 Gb/in².

However, to realize a yet higher recording density exceeding 200 Gb/in², it is necessary not only to change from the longitudinal magnetic recording method to the perpendicular magnetic recording method as described above, but also to improve the magnetic recording medium itself.

As an example of a perpendicular magnetic recording medium, a “continuous medium” is known in which the various layers constituting the recording medium are formed uniformly and flat over the whole of the substrate by sputtering. However, if the recording density exceeds 200 Gb/in², then a phenomenon of undesired writing to an adjacent data track may occur markedly due to side fringing produced from a side face of a magnetic recording head, and this may bring about a deterioration in the magnetization data recorded on the adjacent data track. Moreover, during reading of the magnetization data on a data track by a playback head, the signal-noise ratio (hereinafter referred to as “SNR”) may decrease due to leakage magnetic flux from an adjacent track.

As art for avoiding these problems and realizing a further improvement in recording density, there has been disclosed a discrete track type recording medium in which the magnetic recording layer is not present between a plurality of data tracks for recording and playback of magnetization data as shown in FIG. 3. In FIG. 3, reference numeral 31 designates a substrate, 32 designates a soft magnetic backing layer, 33 designates a base layer for crystal orientation, 34 designates a data track, and 35 designates a groove between data tracks.

As an example of such a discrete track type recording medium, in Japanese Patent Application Laid-open No. S56-119934 there is disclosed a medium of a type in which a spiral concavo-convex pattern structure is formed on a substrate surface, and as shown in FIG. 4 a magnetic material that will form a magnetic recording layer is embedded in the concave parts. In FIG. 4, reference numeral 41 designates a substrate or a nonmagnetic material, 42 designates a concave part, 43 designates a convex part, 44 designates a magnetic material embedded in the concave parts, and 45 designates a data track.

Moreover, examples of art relating to a discrete track type recording medium formed using a different method are described in Japanese Patent Application Laid-open No. S56-119934 are in Japanese Patent Application Laid-open No. S58-118028 and Japanese Patent Application Laid-open No. H5-81640. In these documents there is disclosed a method in which a magnetic recording layer is formed uniformly and flat over the whole surface of a medium substrate, and then the magnetic recording layer is directly cut so as to form concave parts between the tracks.

An example of a discrete track type recording medium manufactured using the method described in Japanese Patent Application Laid-open No. S58-118028 is shown in FIG. 5. In FIG. 5, reference numeral 51 designates a substrate, 52 designates a soft magnetic backing layer, 53 designates a convex part of the magnetic recording layer remaining after the cutting, this corresponding to a data track for recording and playback of magnetization data, 54 designates a concave part where the magnetic recording layer has been cut away, this corresponding to between tracks, and 55 designates a material embedded in the concave parts. The concave parts 54 obtained through the cutting may be filled with a nonmagnetic material, a material having a higher magnetic permeability than the magnetic recording layer 53, or a combination thereof.

Furthermore, as another method of forming a magnetic recording medium, in Japanese Patent Application Laid-open No. 2003-16622, there is disclosed a method in which a surface of a soft magnetic backing layer formed on a substrate is cut so as to form a concavo-convex pattern structure, and then a nonmagnetic layer is embedded in the concave parts and flattening is carried out, and a magnetic recording layer is formed flat thereon. A sectional view of a discrete track type recording medium manufactured using such a method is shown in FIG. 6. In FIG. 6, reference numeral 61 designates a substrate, 62 designates a soft magnetic backing layer having a concavo-convex pattern structure, 63 designates a nonmagnetic layer embedded in the concave parts, 64 designates a magnetic recording layer, and 65 designates a data track.

In addition, the following art has been disclosed as art relating to above Japanese Patent Application Laid-open No. S56-119934, Japanese Patent Application Laid-open No. S58-118028, Japanese Patent Application Laid-open No. H5-81640, and Japanese Patent Application Laid-open No. 2003-16622.

In Japanese Patent Application Laid-open No. 2006-127681, there is disclosed a method of manufacturing a magnetic recording medium comprising a step of forming a soft magnetic backing layer on a nonmagnetic substrate, a step of forming on a surface of the soft magnetic backing layer a concavo-convex pattern structure comprising convex parts corresponding to positions of data tracks for recording magnetization data and concave parts corresponding to positions between the data tracks, a step of forming on the concavo-convex pattern structure a base layer for crystal orientation that is laminated uniformly on the concave parts and the convex parts so as to follow the concavo-convex pattern structure, and a step of forming on the base layer for crystal orientation a perpendicular magnetic recording layer that is laminated uniformly on the concave parts and the convex parts so as to follow the concavo-convex pattern structure.

In Japanese Patent Application Laid-open No. 2003-178431, there is disclosed a method of manufacturing a perpendicular two-layer patterned medium in which a magnetic recording layer of the perpendicular magnetic recording medium is magnetically divided by a regular fine pattern, the method having a first step of carrying out film formation on the substrate up to a soft magnetic layer and then coating on a thermoplastic resin, a second step of transferring a fine pattern onto the thermoplastic resin by molding through application of heat and pressure, and a third step of embedding a magnetic recording layer into concave parts of the pattern.

In Japanese Patent Application Laid-open No. 2004-227639, there is disclosed a method of manufacturing a perpendicular magnetic recording medium in which a soft magnetic backing layer comprising polymer-containing soft magnetic ultra-fine particles is formed on a nonmagnetic substrate, a base layer is formed on the soft magnetic backing layer, an intermediate layer is formed on the base layer, a magnetic recording layer is formed on the intermediate layer, a protective film is formed on the magnetic recording layer, and a liquid lubricant layer is formed on the protective film, the method further having, after the formation of the soft magnetic backing layer, a step of heating the soft magnetic backing layer, and pressing using a stamper whose surface facing the soft magnetic backing layer is flat.

Among Japanese Patent Application Laid-open No. S56-119934, Japanese Patent Application Laid-open No. S58-118028, Japanese Patent Application Laid-open No. H5-81640, Japanese Patent Application Laid-open No. 2003-16622, Japanese Patent Application Laid-open No. 2006-127681, Japanese Patent Application Laid-open No. 2003-178431, and Japanese Patent Application Laid-open No. 2004-227639, in Japanese Patent Application Laid-open No. S56-119934, as described above, a spiral concavo-convex pattern structure is formed on the substrate surface, and a magnetic material that will form a magnetic recording layer is embedded in the concave parts, so as to form data tracks for writing and reading magnetization data. Under such formation conditions, to make crystal growth occur with the crystal orientation and magnetic anisotropy suitably controlled, it is important to optimize the selection of the base layer and the sputtering conditions. For the reason that it is difficult to completely eliminate residue after processing using an ordinary processing process, it is thus difficult to form a magnetic material having good perpendicular anisotropy in fine grooves of width of not more than a few hundred nanometers.

In Japanese Patent Application Laid-open No. S58-118028 and Japanese Patent Application Laid-open No. H5-81640, as shown in FIG. 5, magnetic recording layer 53 is formed uniformly and flat over the whole surface of the medium substrate surface, and then the magnetic recording layer is directly cut so as to form concave parts 54 between the tracks. In this medium manufacturing method, wet etching or any of various dry etching techniques such as RIE (reactive ion etching) or etching using a focused ion beam is used as the cutting method. With these techniques, the magnetic recording layer is cut using chemical or physical means, and hence even if the parts corresponding to the data tracks are protected with a resist during the cutting, the magnetic properties of magnetic recording layer 53 at the data track parts may deteriorate due to the heat history during the cutting, chemical erosion or the like.

In Japanese Patent Application Laid-open No. 2003-16622, as shown in FIG. 6, a concavo-convex pattern structure is formed on soft magnetic backing layer 62 by fine processing, nonmagnetic material 63 is embedded in the concave parts, flattening is carried out by CMP (chemical mechanical polishing), and then magnetic recording layer 64 is formed on flat. With this method, magnetic recording layer 64 is not subjected to the fine processing, but the surface of soft magnetic backing layer 62 and nonmagnetic material 63 contacting magnetic recording layer 64 constituting data tracks 65 is subjected to the CMP processing. The stability of the crystal structure at the surface of these layers 62 and 63 may thus be marred due to the heat history during the CMP processing or chemical erosion, and hence the crystal orientation and magnetic anisotropy of magnetic recording layer 64 formed thereon may deteriorate.

In all of the magnetic recording medium examples shown in FIGS. 4 and 5 (Japanese Patent Application Laid-open No. S56-119934, Japanese Patent Application Laid-open No. S58-118028, and Japanese Patent Application Laid-open No. H5-81640), some substance is embedded in the concave parts of the concavo-convex pattern structure, and hence CMP processing of the surface of the magnetic recording layer is essential. In this case, the surface of the magnetic recording layer is directly subjected to the CMP processing, and hence deterioration of the magnetic properties of the magnetic recording layer is unavoidable. Moreover, due to the CMP processing being included in the medium manufacturing process, the manufacturing cost increases. Furthermore, cutting waste is generated in the CMP processing, and hence the processed surface must be washed carefully to remove the generated waste, and thus the manufacturing process becomes more complicated.

In Japanese Patent Application Laid-open No. 2006-127681, the concavo-convex structure is formed by cutting or the like, and hence the crystal orientation and magnetic anisotropy of the magnetic recording layer ultimately used as the data tracks may deteriorate due to the same problems as for Japanese Patent Application Laid-open No. 2003-16622, i.e., the heat history during the cutting or chemical erosion.

In Japanese Patent Application Laid-open No. 2003-178431 and Japanese Patent Application Laid-open No. 2004-227639, the concavo-convex pattern is formed on a resin film by pressing with a stamper. All of the layers must thus be formed on a substrate having thereon a concavo-convex pattern having a high aspect ratio, and hence securing uniformity of film thickness is difficult, and thus it may not be possible to obtain the desired magnetic recording medium.

The present invention is directed to overcoming or at least reducing the effects of one or more of the problems set forth above.

### SUMMARY OF THE INVENTION

It is an object of the present invention to solve the problems of Japanese Patent Application Laid-open No. S56-119934, Japanese Patent Application Laid-open No. S58-118028, Japanese Patent Application Laid-open No. H5-81640, Japanese Patent Application Laid-open No. 2003-16622, Japanese Patent Application Laid-open No. 2006-127681, Japanese Patent Application Laid-open No. 2003-178431, and Japanese Patent Application Laid-open No. 2004-227639, and to provide a discrete track type perpendicular magnetic recording medium that can be manufactured using a simple, inexpensive method, and that has, moreover, good crystal orientation and magnetic properties such as perpendicular magnetic anisotropy. Moreover, it is an object of the present invention also to provide a method of manufacturing such a magnetic recording medium.

The present invention relates to a magnetic recording medium in which a soft magnetic backing layer, a base layer for crystal orientation, and a perpendicular magnetic recording layer are formed in this order on a nonmagnetic substrate, wherein a processing layer having a concavo-convex pattern comprising convex parts at a low density and concave parts at a higher density is provided between the nonmagnetic substrate and the perpendicular magnetic recording layer, and the concavo-convex pattern shape of the processing layer is reflected on the perpendicular magnetic recording layer. The magnetic recording medium of the present invention can be manufactured simply and inexpensively and moreover has excellent magnetic properties. For the magnetic recording medium of the present invention, the concavo-convex pattern of the processing layer preferably is formed by pressing parts of the perpendicular magnetic recording layer not used as data tracks so as to compress a layer having a poorer resistance to application of pressure than the soft magnetic backing layer, the base layer for crystal orientation, and the perpendicular magnetic recording layer. The convex parts of the processing layer preferably have a relative film density of not more than 50%. The processing layer is preferably formed between the nonmagnetic substrate and the soft magnetic backing layer, or between the soft magnetic backing layer and the base layer for crystal orientation, or between the base layer for crystal orientation and the perpendicular magnetic recording layer.

The present invention includes a magnetic recording medium in which a soft magnetic backing layer, a base layer for crystal orientation, and a perpendicular magnetic recording layer are formed in this order on a nonmagnetic substrate, wherein at least one of the soft magnetic backing layer and the base layer for crystal orientation has a concavo-convex pattern comprising convex parts at a low density and concave parts at a higher density, and the concavo-convex pattern shape is reflected on the perpendicular magnetic recording layer. For such a magnetic recording medium, the various preferable features relating to the concavo-convex pattern for the case of the magnetic recording medium including a processing layer as described above are preferably applied to the soft magnetic backing layer and/or the base layer for crystal orientation.

The present invention also relates to a method of manufacturing a magnetic recording medium in which a soft magnetic backing layer, a base layer for crystal orientation, and a perpendicular magnetic recording layer are formed in this order on a nonmagnetic substrate, and a processing layer is formed between the nonmagnetic substrate and the perpendicular magnetic recording layer, parts of the perpendicular magnetic recording layer being used as data tracks, the method comprising a step of forming the soft magnetic backing layer, the base layer for crystal orientation, the perpendicular magnetic recording layer, and the processing layer on the nonmagnetic substrate, and a step of pressing parts of the perpendicular magnetic recording layer not used as data tracks so as to compress the processing layer and thus form a concavo-convex surface pattern. In the method of manufacturing a magnetic recording medium of the present invention, the processing layer is preferably a sputtered metal film pressed with a pressure of not less than 40 mTorr. Moreover, the processing layer is preferably formed between the nonmagnetic substrate and the soft magnetic backing layer, or between the soft magnetic backing layer and the base layer for crystal orientation, or between the base layer for crystal orientation and the perpendicular magnetic recording layer.

The present invention also includes a method of manufacturing a magnetic recording medium in which a soft magnetic backing layer, a base layer for crystal orientation, and a perpendicular magnetic recording layer are formed in this order on a nonmagnetic substrate, parts of the perpendicular magnetic recording layer being used as data tracks, the method comprising a step of forming the soft magnetic backing layer, the base layer for crystal orientation, and the perpendicular magnetic recording layer on the nonmagnetic substrate, and a step of pressing parts of the perpendicular magnetic recording layer not used as data tracks so as to compress at least one of the soft magnetic backing layer and the base layer for crystal orientation and thus form a concavo-convex surface pattern. For such a method of manufacturing a magnetic recording medium, the preferable features relating to the form of pressing for the case of the magnetic recording medium including a processing layer as described above are preferably applied to the soft magnetic backing layer and/or the base layer for crystal orientation.

According to the present invention, instead of using processing means such as cutting or etching as in a conventional perpendicular magnetic recording medium manufacturing process, a simple process of merely applying pressure to the laminate, i.e., a process of merely pressing parts of the perpendicular magnetic recording layer not used as data tracks, is used, whereby a discrete track type perpendicular magnetic recording medium can be obtained simply and inexpensively.

According to the present invention, throughout the whole manufacture including during the application of pressure to the laminate, parts of the magnetic recording layer corresponding to data tracks for recording and playback of magnetization data are not subjected to any load. In other words, the parts corresponding to the data tracks are not processed in any way. Consequently, whereas the crystal orientation and magnetic properties such as the perpendicular magnetic anisotropy generally deteriorate upon processing a magnetic recording layer, with the recording medium obtained through the present invention, the magnetic recording layer can be made to have excellent magnetic properties.

### BRIEF DESCRIPTION OF THE DRAWINGS

The foregoing advantages and features of the invention will become apparent upon reference to the following detailed description and the accompanying drawings, of which:

FIG. 1 is a sectional view showing an example of a discrete track type perpendicular magnetic recording medium of the present invention;

FIG. 2 is sectional views showing in order steps of a method of manufacturing the magnetic recording medium of the present invention;

FIG. 3 is a perspective view showing a discrete track medium in which a magnetic recording layer is not present between adjacent data tracks having magnetization data thereon;

FIG. 4 is a sectional view showing a medium of a type in which a concavo-convex pattern structure is formed on a substrate surface, and a magnetic material that will form a magnetic recording layer is embedded in concave parts thereof;

FIG. 5 is a sectional view showing an example of a discrete track type magnetic recording medium manufactured using a method described in Japanese Patent Application Laid-open No. S58-118028; and

FIG. 6 is a sectional view showing a discrete track type magnetic recording medium obtained by cutting a surface of a soft magnetic backing layer formed on a substrate so as to form a concavo-convex pattern structure, then embedding a nonmagnetic layer in concave parts and flattening, and then forming a magnetic recording layer flat thereon.

### DETAILED DESCRIPTION OF SPECIFIC EMBODIMENTS

Following is a detailed description of embodiments of the present invention with reference to the drawings.

### Magnetic Recording Medium

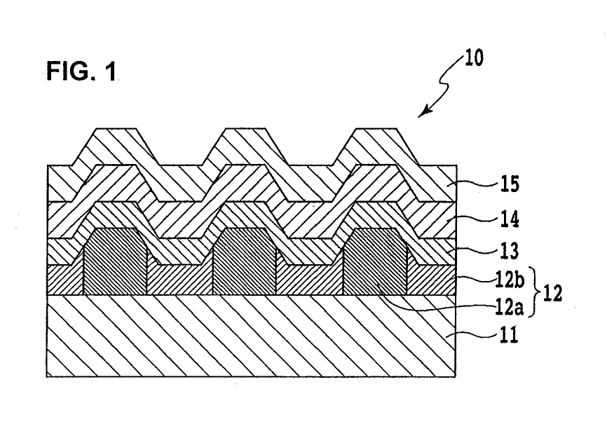

FIG. 1 is a sectional view showing an example of a discrete track type perpendicular magnetic recording medium of the present invention. The discrete track type perpendicular magnetic recording medium 10 shown in FIG. 1 is a laminate in which processing layer 12, soft magnetic backing layer 13, base layer for crystal orientation 14, and perpendicular magnetic recording layer 15 are laminated in this order on nonmagnetic substrate 11.

As nonmagnetic substrate 11, any of various glass substrates, or a substrate of a metal such as aluminum, or silicon, plastic or the like may be used. The thickness of nonmagnetic substrate 11 is preferably from 0.1 to 1 mm so as to insure substrate rigidity while not making the moment of inertia too high.

Processing layer 12 is preferably a thin film having a poorer resistance to application of pressure prior to pressing than the other layers 13 to 15 constituting the laminate shown in FIG. 1. Moreover, as shown in FIG. 1, as a result of the pressing processing layer 12 comes to comprise thick film parts 12a and thin film parts 12b having the same composition as one another, and moreover the density of thin film parts 12b is higher than that of thick film parts 12a. The relative film density of processing layer 12 is preferably not more than 50% so that the difference in the thickness after the processing between thick film parts 12a and thin film parts 12b is sufficient. Here, the relative film density means the density of the layer in question (here, processing layer 12) before compression relative to the density in a bulk (single crystal) state of that layer (here, processing layer 12). As such a processing layer 12, any of various films can be used, for example a film obtained by sputtering at a high gas pressure, or a film evenly containing voids. For example, a porous low-permittivity film as used in semiconductors can be used. The film density can also be reduced so as to reduce the resistance to application of pressure by using a vapor deposition method or by reducing the film formation temperature in any of various film formation methods. To insure that the thickness difference after processing between the maximum thickness and the minimum thickness is not less than 10 nm, the relative film density of processing layer 12 is preferably low, and moreover the thickness of processing layer 12 is preferably high. In the present studies, it was necessary to make the relative density of processing layer 12 be not more than 50%. In this case, the thickness must be not less than a minimum of 20 nm; the thickness is preferably not more than 1000 nm for practicality.

There are no particular limitations on soft magnetic backing layer 13, but soft magnetic backing layer 13 preferably contains at least one of Fe, Co, Ni, Ta, and Zr. For example, an amorphous film having a composition such as CoZrNb or CoZrTa may be used. Soft magnetic backing layer 13 may be constituted as a single layer film having a specified composition or, to produce a single magnetic domain with an objective of reducing noise for the recording medium, soft magnetic backing layer 13 may alternatively be a laminated film in which a plurality of magnetic films are coupled together ferromagnetically or antiferromagnetically. The thickness of soft magnetic backing layer 13 is preferably from 1 to 100 nm from the viewpoint of balance between the electromagnetic conversion properties, in particular the SNR, and the overwrite properties.

For base layer for crystal orientation 14, it is important to select an element and a thickness suitable for the group of elements constituting perpendicular magnetic recording layer 15, described below, and the crystal structure of perpendicular magnetic recording layer 15. For example, in the case that magnetic recording layer 15 is a CoCr type layer having a hexagonal crystal system, to grow the recording layer epitaxially from the base layer, it is preferable to use a metal such as Ru, Re or Os that also has a hexagonal crystal system, or an alloy thereof. The thickness of base layer for crystal orientation 14 is preferably from 5 to 50 nm from the viewpoint of the balance between the electromagnetic conversion properties, in particular the SNR, and leaching out of Co.

There are no particular limitations on perpendicular magnetic recording layer 15 so long as this is a layer having magnetic anisotropy in a direction perpendicular to nonmagnetic substrate 11, but perpendicular magnetic recording layer 15 preferably contains at least one element selected from Fe, Co, Cr, Pt, Pd, Si, and Os. The thickness of perpendicular magnetic recording layer 15 is preferably from 1 to 30 nm from the viewpoint of the balance between the electromagnetic conversion properties, in particular the SNR, and the overwrite properties.

For the discrete track type perpendicular magnetic recording medium of the present invention comprising the constituent components described above, as described in the section below on the manufacturing method, when pressure is applied to the laminate, parts corresponding to data tracks (in FIG. 1, the parts of layers 12 to 15 where processing layer 12 has the maximum thickness in a horizontal direction) are not processed in any way. For the recording medium shown in FIG. 1, the magnetic recording layer can thus be made to have excellent crystal orientation and magnetic properties such as perpendicular magnetic anisotropy.

### Method of Manufacturing Magnetic Recording Medium

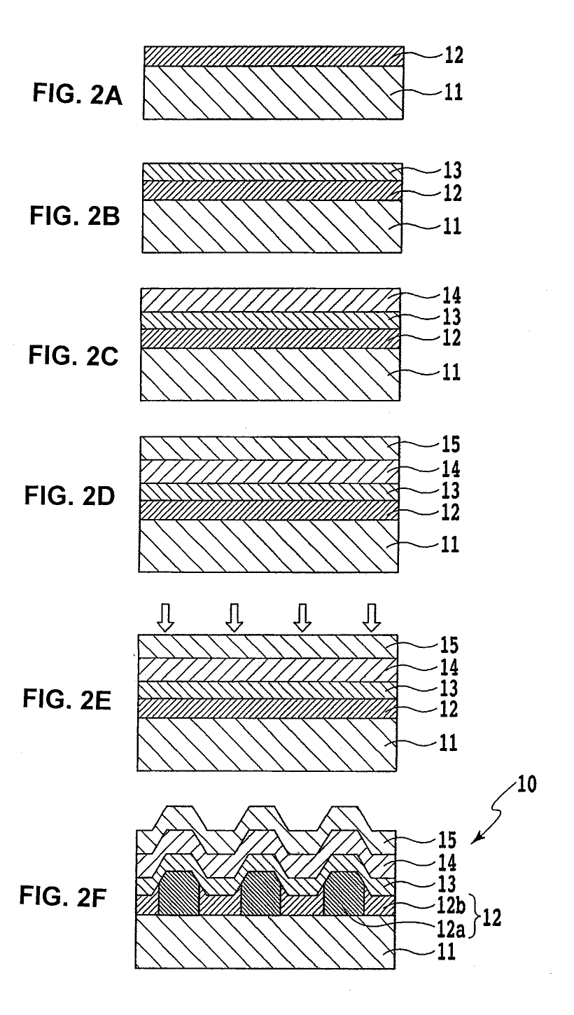

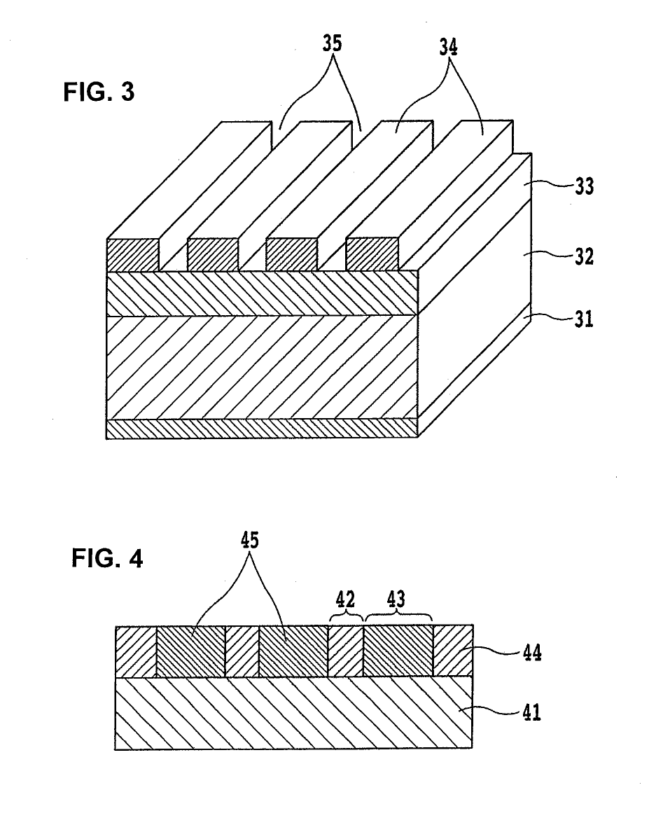

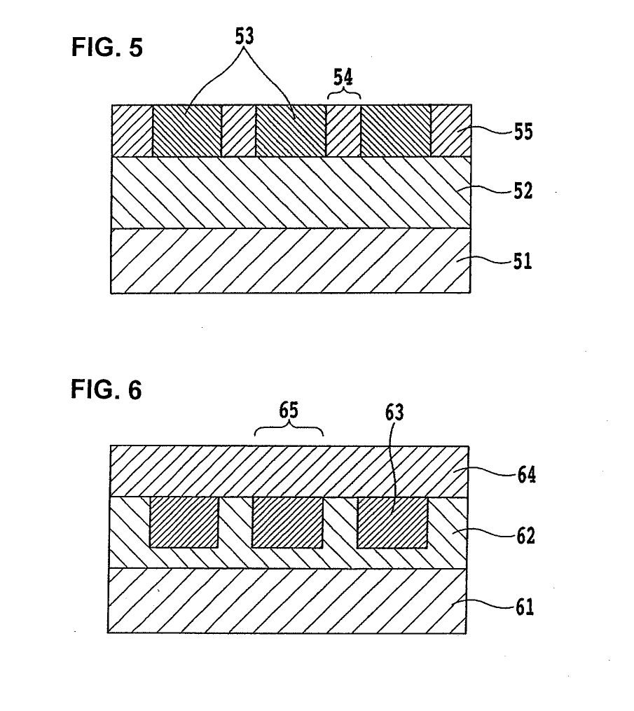

FIG. 2 is sectional views showing in order steps of a method of manufacturing the magnetic recording medium of the present invention. In the manufacturing method of the present invention, first, as shown in FIG. 2A, processing layer 12 is laminated on nonmagnetic substrate 11. Regarding the form of lamination, any of various film formation methods may be used. In particular, from the viewpoint of uniformity and film formation rate, it is preferable to use magnetron sputtering. Moreover, in the case of using magnetron sputtering, from the viewpoint of controllability of the sputtering conditions, a DC discharge is preferable, and moreover to reduce the film density it is further preferable to set the sputtering pressure high. For example, with a sputtering pressure not less than 40 mTorr, the film has a columnar structure, with many grain boundaries being formed at a low density, and hence the film density can be reduced.

Next, as shown in FIG. 2B, soft magnetic backing layer 13 is laminated on processing layer 12. Regarding the form of lamination, any of various sputtering methods may be used. In particular, from the viewpoint of uniformity and film formation rate, it is preferable to use magnetron sputtering. Moreover, in the case of using magnetron sputtering, from the viewpoint of controllability of the sputtering conditions, a DC discharge is particularly preferably used. Furthermore, as soft magnetic backing layer 13, there may also be used an antiferromagnetically coupled two-layer film for controlling magnetic domains in the soft magnetic film.

Then, as shown in FIG. 2C, a base layer for crystal orientation 14 is laminated on soft magnetic backing layer 13. Regarding the form of lamination, any of various sputtering methods may be used. In particular, from the viewpoint of uniformity and film formation rate, it is preferable to use magnetron sputtering. Moreover, in the case of using magnetron sputtering, a DC discharge is particularly preferably used from the viewpoint of controllability of the sputtering conditions. Furthermore, the base layer for crystal orientation need not be a single layer, but rather may also have a multi-layer structure including a so-called seed layer.

Then, as shown in FIG. 2D, perpendicular magnetic recording layer 15 is laminated on base layer for crystal orientation 14. Regarding the form of lamination, any of various sputtering methods may be used. In particular, from the viewpoint of uniformity and film formation rate, it is preferable to use magnetron sputtering. In the case of using magnetron sputtering, from the viewpoint of controllability of the sputtering conditions, a DC discharge is particularly preferably used.

After processing layer 12, soft magnetic backing layer 13, base layer for crystal orientation 14, and perpendicular magnetic recording layer 15 have been laminated on nonmagnetic substrate 11 in this order in this way, as shown in FIG. 2E, pressure is applied to parts of thin films 12 to 15 constituting the laminate. Here, the positions where the pressure is applied are positions that will not be used as data tracks in the future; in FIG. 2E, the four parts shown by the four arrows are such parts not corresponding to data tracks.

Here it is important to make processing layer 12 of a material having a poorer resistance to application of pressure than the other layers 13 to 15 when in the state shown in FIG. 2E. In this way, upon applying the pressure to the parts of the thin films 12 to 15 not corresponding to data tracks, processing layer 12 which has a poorer resistance to application of pressure than the other layers 13 to 15 is compressed in places, so that the thickness of processing layer 12 becomes nonuniform in a horizontal direction. That is, as shown in FIG. 2F, a concavo-convex pattern comprising convex parts 12a at a low density and concave parts 12b at a higher density is formed on processing layer 12. Because processing layer 12 is compressed preferentially, soft magnetic backing layer 13, base layer for crystal orientation 14, and perpendicular magnetic recording layer 15 are not compressed, but rather drop down in places accompanying the compression of processing layer 12, with the thickness of each of these layers not changing as much as for processing layer 12 in the horizontal direction.

As specific means for compressing processing layer 12, there can be used, for example, a method using a die such as imprinting, or a method in which parts are pressed using a small needle or head. Regarding the timing at which the concavo-convex shape is formed through the application of pressure, this may be any time after the formation of processing layer 12, regardless of whether layers 13 to 15 above processing layer 12 have been laminated on. For example, the timing may be directly after the laminating on of processing layer 12, or directly after the laminating on of magnetic recording layer 15.

The example described above is merely an example, it also being possible, for example, to provide processing layer 12 between soft magnetic backing layer 13 and base layer for crystal orientation 14, or between base layer for crystal orientation 14 and magnetic recording layer 15 instead of between nonmagnetic substrate 11 and soft magnetic backing layer 13.

It is also possible to not use processing layer 12 itself, but rather make soft magnetic backing layer 13 or base layer for crystal orientation 14 additionally function as processing layer 12, i.e., have a function of being compressed as described above. Thus, soft magnetic backing layer 13 or base layer for crystal orientation 14 can act as a processing layer instead. In such a case, it is important to make at least one of soft magnetic backing layer 13 and base layer for crystal orientation 14 be of a material having a poorer resistance to application of pressure than perpendicular magnetic recording layer 15 when in the state after lamination of the substrate and the perpendicular magnetic recording layer.

Furthermore, as a variation of the example shown in FIG. 2, although not shown, it is also preferable to optionally form a protective film having carbon as a main component thereof on magnetic recording layer 15, this being so that magnetic recording layer 15 can be prevented from being damaged when the recording medium is subjected to playback using a recording/playback head. Moreover, by applying a lubricant comprising a fluorinated compound onto the protective film, sliding of the recording/playback head can be improved. In the case of using such a protective film and/or lubricant, the laminate is compressed in places after these have been formed/or applied.

With the method of manufacturing the magnetic recording medium of the present invention comprising the steps described above, instead of using processing means such as cutting or etching as in a conventional perpendicular magnetic recording medium manufacturing process, a simple process of merely applying pressure to the laminate is used, whereby the discrete track type perpendicular magnetic recording medium can be obtained simply and inexpensively. In particular, because means such as cutting or etching is not used in the manufacturing method, there is no problem of cutting waste being generated, and hence there is the advantage that there is no need to carefully wash the processed surface so as to remove such generated waste.

In the above manufacturing method, when the pressure is applied to the laminate, the parts of the magnetic recording layer corresponding to data tracks for recording and playback of magnetization data are not subjected to any load, in other words the manufacturing method is such that the parts corresponding to the data tracks are not processed in any way. For the recording medium obtained, there is thus no deterioration of the magnetic properties of the magnetic recording layer caused by the heat history due to such processing, chemical erosion or the like, which has been a problem with the conventional art, and hence the magnetic recording layer can be made to have excellent crystal orientation, perpendicular magnetic anisotropy and so on.

Following is a demonstration of the effects of the present invention, giving an example of the present invention.

### Example

A discrete track type perpendicular magnetic recording medium as shown in FIG. 1 was manufactured as follows. First, using a glass substrate as a nonmagnetic substrate, a 50 nm Al—Nd film was laminated thereon as a processing layer using DC magnetron sputtering. As the sputtering conditions, an argon gas atmosphere was used, the pressure was maintained at 0.1 Torr, and the discharge power was 0.8 kW.

Next, a 50 nm CoZrNb film was laminated as a soft magnetic backing layer on the processing layer using DC magnetron sputtering. As the sputtering conditions, an argon gas atmosphere was used, the pressure was maintained at 5 mTorr, and the discharge power was 1.0 kW.

Then, a 15 nm Ru film was laminated as a base layer for crystal orientation on the soft magnetic backing layer using DC magnetron sputtering. As the sputtering conditions, an argon gas atmosphere was used, the pressure was maintained at 70 mTorr, and the discharge power was 0.8 kW.

Then, a 10 nm CoCrPt—SiO₂ granular film, and a 10 nm CoCrPtB film were laminated in this order as a perpendicular magnetic recording layer on the base layer for crystal orientation using DC magnetron sputtering. As the sputtering conditions, for the CoCrPt—SiO₂ granular film, an argon gas atmosphere containing 5 vol % of oxygen was used, the pressure was maintained at 30 mTorr, and the discharge power was 0.7 kW. On the other hand, for the CoCrPtB film, an argon gas atmosphere was used, the pressure was maintained at 10 mTorr, and the discharge power was 0.7 kW.

The medium thus manufactured was taken out into the atmosphere, and pressure was applied in places using an imprinting method, whereby a concavo-convex shape was formed. The imprinting conditions were a pressure of 80 MPa at room temperature, and the imprinting mold was made of quartz glass. The mold used was manufactured using ordinary lithography and dry etching methods, and had concentric circular lines of line width 100 nm, space width 100 nm, and depth 200 nm formed over the whole surface of a donut shape of outside diameter 65 mm and inside diameter 20 mm.

For the medium manufactured, the surface of the medium after the imprinting was inspected by AFM, whereupon it was found that a concavo-convex surface shape had been formed with a height difference of approximately 15 nm when viewed in section. The thickness of each of the layers in the processed parts was then examined using a sectional TEM photograph. The results are shown in Table 1 together with the relative film density which was estimated from single layer film X-ray reflectivity measurement. Here, X-ray reflectivity measurement is a method of inferring the density by fitting the low angle reflection pattern in XRD θ-2θ scan based on the thickness/surface roughness. Moreover, the relative film density means the density of the layer in question before compression relative to the density in a bulk (single crystal) state for that layer.

TABLE 1

| | Relative film | Thickness after | Change due to |
|---|---|---|---|
| | density | processing | processing |
| Processing layer | 40% | 36 nm | −14 nm |
| Soft magnetic backing | 76% | 50 nm | 0 |
| layer | | | |
| Base layer for crystal | 49% | 13 nm | −2 nm |
| orientation | | | |
| Perpendicular magnetic | 65% | 20 nm | 0 |
| recording layer | | | |

According to Table 1, it can be seen that the concavo-convex pattern is formed primarily through a decrease in the thickness of the processing layer. Moreover, for the unprocessed parts (the soft magnetic backing layer, the base layer for crystal orientation, and the perpendicular magnetic recording layer), the thickness was hardly changed compared with before the imprinting. This result shows that a film having a relative film density of not more than 50% is required as the processing layer.

Accordingly, through the present example, it was demonstrated that a concavo-convex shape of a magnetic recording medium can be formed through a simple, inexpensive method. Moreover, through the present example, it was demonstrated that the concavo-convex shape can be realized without subjecting parts that will used as data tracks to processing in any way, so that deterioration in the magnetic properties of the magnetic recording layer due to such processing can be eliminated, and hence the crystal orientation and perpendicular magnetic anisotropy of the magnetic recording layer are good.

According to the present invention, as described above, a magnetic recording medium can be obtained using a simple, inexpensive method, and moreover the crystal orientation and perpendicular magnetic anisotropy of the magnetic recording layer are good. The present invention is thus promising in terms of being able to provide a discrete track type perpendicular magnetic recording medium able to be installed in any of various magnetic disk apparatuses for which increased recording density has come to be demanded more and more in recent years.

Thus, a magnetic recording medium and method of manufacturing the same has been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

What is claimed is:

1. A magnetic recording medium comprising:
a soft magnetic backing layer, a base layer for crystal orientation, and a perpendicular magnetic recording layer in this order on a nonmagnetic substrate, and
a processing layer between the nonmagnetic substrate and the perpendicular magnetic recording layer, the processing layer having a concavo-convex pattern comprising convex parts at a low density and concave parts at a higher density wherein the concavo-convex pattern shape of the processing layer is reproduced in a pattern shape of the perpendicular magnetic recording layer.

2. The magnetic recording medium according to claim 1, wherein the processing layer has a poorer resistance to application of pressure than the soft magnetic backing layer, the base layer for crystal orientation, and the perpendicular magnetic recording layer.

3. The magnetic recording medium according to claim 2, wherein the concavo-convex pattern of the processing layer is formed by pressing parts of the perpendicular magnetic recording layer not used as data tracks.

4. The magnetic recording medium according to claim 1, wherein the convex parts of the processing layer have a relative film density of not more than 50%.

5. The magnetic recording medium according to claim 1, wherein the processing layer is between the nonmagnetic substrate and the soft magnetic backing layer.

6. The magnetic recording medium according to claim 1, wherein the processing layer is between the soft magnetic backing layer and the base layer for crystal orientation.

7. The magnetic recording medium according to claim 1, wherein the processing layer is between the base layer for crystal orientation and the perpendicular magnetic recording layer.

8. A magnetic recording medium comprising:
a soft magnetic backing layer, a base layer for crystal orientation, and a perpendicular magnetic recording layer in this order on a nonmagnetic substrate,
wherein at least one of the soft magnetic backing layer and the base layer for crystal orientation has a concavo-convex pattern comprising convex parts at a low density and concave parts at a higher density, and the concavo-convex pattern shape is reproduced in a pattern shape of the perpendicular magnetic recording layer.

9. The magnetic recording medium according to claim 8, further comprising a layer having a poorer resistance to application of pressure than the soft magnetic backing layer, the base layer for crystal orientation, and the perpendicular magnetic recording layer.

10. The magnetic recording medium according to claim 8, wherein the concavo-convex pattern of the soft magnetic backing layer or the base layer for crystal orientation is formed by pressing parts of the perpendicular magnetic recording layer not used as data tracks so as to compress the layer having poorer resistance to application of pressure.

11. The magnetic recording medium according to claim 8, wherein the convex parts of the soft magnetic backing layer or the base layer for crystal orientation have a relative film density of not more than 50%.

12. A method of manufacturing a magnetic recording medium comprising a soft magnetic backing layer, a base layer for crystal orientation, and a perpendicular magnetic recording layer in this order on a nonmagnetic substrate, and a processing layer between the nonmagnetic substrate and the perpendicular magnetic recording layer, parts of the perpendicular magnetic recording layer being used as data tracks, the method comprising:
forming the soft magnetic backing layer, the base layer for crystal orientation, the perpendicular magnetic recording layer, and the processing layer on the nonmagnetic substrate; and
pressing parts of the perpendicular magnetic recording layer not used as data tracks so as to compress the processing layer and thus form a concavo-convex surface pattern.

13. The method of manufacturing a magnetic recording medium according to claim 12, wherein the processing layer is a sputtered metal film pressed with a pressure of not less than 40 mTorr.

14. The method of manufacturing a magnetic recording medium according to claim 12, wherein the processing layer is formed between the nonmagnetic substrate and the soft magnetic backing layer.

15. The method of manufacturing a magnetic recording medium according to claim 12, wherein the processing layer is formed between the soft magnetic backing layer and the base layer for crystal orientation.

16. The method of manufacturing a magnetic recording medium according to claim 12, wherein the processing layer is formed between the base layer for crystal orientation and the perpendicular magnetic recording layer.

17. A method of manufacturing a magnetic recording medium in which a soft magnetic backing layer, a base layer for crystal orientation, and a perpendicular magnetic recording layer are formed in this order on a nonmagnetic substrate, parts of the perpendicular magnetic recording layer being used as data tracks, the method comprising:
forming the soft magnetic backing layer, the base layer for crystal orientation, and the perpendicular magnetic recording layer on the nonmagnetic substrate; and
pressing parts of the perpendicular magnetic recording layer not used as data tracks so as to compress at least one of the soft magnetic backing layer and the base layer for crystal orientation and thus form a concavo-convex surface pattern.

18. The method of manufacturing a magnetic recording medium according to claim 17, wherein the soft magnetic backing layer or the base layer for crystal orientation is a sputtered metal film pressed with a pressure of not less than 40 mTorr.
